(19) United States
(12) Patent Application Publication
(10) Pub. No.: US 2018/0142649 A1
(43) Pub. Date: May 24, 2018

(54) WATER VAPOR SUPPLY APPARATUS FOR INTERNAL COMBUSTION ENGINE

(71) Applicants: Hyundai Motor Company, Seoul (KR); Kia Motors Corporation, Seoul (KR)

(72) Inventor: Young Sang YOO, Seoul (KR)

(73) Assignees: Hyundai Motor Company, Seoul (KR); Kia Motors Corporation, Seoul (KR)

(21) Appl. No.: 15/605,704

(22) Filed: May 25, 2017

(30) Foreign Application Priority Data
Nov. 24, 2016 (KR) 10-2016-0157515

(51) Int. Cl. F02M 25/035; F02D 9/02; F02M 25/022

(52) U.S. Cl. CPC F02M 25/035; F02M 25/0221; F02D 9/02

(57) ABSTRACT

A water vapor supply apparatus for an internal combustion engine may include a vaporization tank in which water vapor is generated as water is vaporized by use of exhaust gas discharged from an internal combustion engine, and a water injection device that injects the water to the vaporization tank. The water vapor generated from the vaporization tank is supplied into an intake system of the internal combustion engine.

### CROSS-REFERENCE(S) TO RELATED APPLICATIONS

The present application claims priority to Korean Patent Application No. 10-2016-0157515, filed on Nov. 24, 2016, the entire contents of which is incorporated herein for all purposes by this reference.

### BACKGROUND OF THE INVENTION

### Field of the Invention

The present invention relates to a water vapor supply apparatus for an internal combustion engine, and more particularly, relates to a water vapor supply apparatus for an internal combustion engine capable of reducing combustion heat and nitrogen oxide emissions, and significantly improving fuel efficiency by supplying water vapor, which is vaporized by using exhaust gas, to an intake system.

### Description of Related Art

Recently, various technologies have been developed to inhibit nitrogen oxide and hydrocarbon emissions by reducing combustion heat in the combustion of an internal combustion engine, and to improve fuel efficiency by reducing the mixture ratio between air and fuel.

Exhaust gas recirculation (EGR) systems or water injection systems have been studied and developed as representative technologies for reducing the combustion heat and nitrogen oxide emissions, and for improving the fuel efficiency.

Such an EGR system must include an EGR pipe which is used to circulate EGR gas from an exhaust system of the engine to an intake system of the engine, an EGR cooler which cools the EGR gas, and an EGR valve which regulates the flow rate of the EGR gas. An EGR system not only occupies most of a disposition area of a narrow engine compartment, but also increases assembly cost.

In addition, the EGR system operates only in some operating regions of a vehicle because the operation of the EGR system depends on the revolutions per minute (RPM) of an engine. Accordingly, the use range of the EGR gas is significantly restricted. For example, the EGR system may not smoothly operate in a low RPM region and a high RPM region of the engine.

A water injection system directly injects water into an air intake or fuel-air mixture, or directly injects water into a combustion chamber of an engine, thereby lowering the temperature of the combustion chamber. Accordingly, the water injection system may inhibit nitrogen oxide and hydrocarbon emissions, and may improve fuel efficiency by reducing the fuel-air mixture ratio.

However, in the case of the water injection system, as a high-price water injector is required, the manufacturing cost may be increased.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a water vapor supply apparatus for an internal combustion engine configured for reducing combustion heat and nitrogen oxide emissions, and significantly improving fuel efficiency by supplying water vapor, which is vaporized by exhaust gas, to an intake system of the internal combustion engine.

The technical problems to be solved by the present inventive concept are not limited to the aforementioned problems, and any other technical problems not mentioned herein will be clearly understood from the following description by those skilled in the art to which the present invention pertains.

According to various aspects of the present invention, a water vapor system for an internal combustion engine may include a vaporization tank in which water vapor is generated as water is vaporized by use of exhaust gas discharged from an internal combustion engine, and a water injection device that injects the water into the vaporization tank. The water vapor generated from the vaporization tank may be supplied into an intake system of the internal combustion engine.

The water vapor system may further include a water vapor supply pipe that connects the vaporization tank with the intake system of the internal combustion engine. The water vapor generated from the vaporization tank may be supplied into the intake system of the internal combustion engine through the water vapor supply pipe.

The vaporization tank may be disposed in an exhaust system of the internal combustion engine to receive heat of the exhaust gas discharged from the internal combustion engine.

The vaporization tank may be formed therein with a vaporization chamber in which the water is vaporized.

The water vapor supply pipe may connect the vapor tank with an intake port of the intake system.

The water vapor supply pipe may include a supplying opening that communicates with the intake port of the intake system.

The water vapor supply pipe may connect the vaporization tank with an intake pipe of the intake system.

The water vapor supply pipe may include a supplying opening that communicates with the intake port of the intake system.

The water vapor supply pipe may include a supplying opening that communicates with a segment of the intake pipe, in which a throttle valve is disposed.

The water vapor supply pipe may include a supplying opening that communicates with an upstream segment of a throttle valve in the intake pipe.

The water vapor supply pipe may connect the vaporization tank with an intake manifold of the intake system.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view illustrating a water vapor supply apparatus for an internal combustion engine, according to an exemplary embodiment of the present invention;

FIG. 2 is a cross-sectional view illustrating a water vapor supply apparatus for an internal combustion engine, according to another exemplary embodiment of the present invention;

FIG. 3 is a cross-sectional view illustrating a water vapor supply apparatus for an internal combustion engine, according to another exemplary embodiment of the present invention; and

FIG. 4 is a cross-sectional view illustrating a water vapor supply apparatus for an internal combustion engine, according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for examples, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

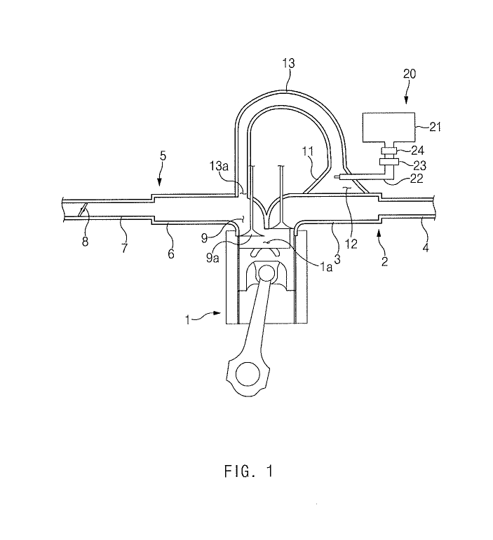

Referring to FIG. 1, according to an exemplary embodiment of the present invention, a water vapor supply apparatus 10 for an internal combustion engine includes a vaporization tank 11 used to generate water vapor, a water vapor supply pipe 13 which connects the vaporization tank 11 with an intake system of an internal combustion engine 1, and a water injection device 20 which injects water into the vaporization tank 11.

The vaporization tank 11 may be disposed in an exhaust system 2 of the internal combustion engine 1 to receive heat of exhaust gas discharged from the internal combustion engine 1.

According to an embodiment, as illustrated in FIG. 1, the vaporization tank 11 may be disposed to make contact with one surface of an exhaust manifold 3 of an exhaust system 2.

Alternatively, the vaporization tank 11 may be disposed to make contact with an exhaust pipe 4 communicating with the exhaust manifold 3.

The vaporization tank 11 may be formed therein with a vaporization chamber 12. Accordingly, when water is injected into the vaporization chamber 12 of the vaporization tank 11, the injected water may be vaporized by heat of the exhaust gas wherein water vapor may be generated.

According to an exemplary embodiment of the present invention, as illustrated in FIG. 1, the water vapor supply pipe 13 may connect the vaporization tank 11 with an intake port 9 of an intake system 5.

The water vapor supply pipe 13 may be formed in one end portion thereof with a supplying opening 13a. The supplying opening 13a of the water vapor supply pipe 13 may communicate with the intake port 9 of the intake system 5. The supplying opening 13a may be located above an intake valve 9a. Accordingly, the water vapor supplied through the water vapor supply pipe 13 may be introduced into a combustion chamber 1a of the internal combustion engine 1 as the intake valve 9a is opened.

As described above, according to an exemplary embodiment of the present invention, as the supplying opening 13a of the water vapor supply pipe 13 communicates with the intake port 9 of the intake system 5, the same function and the same effect as those of a conventional water injection system may be implemented. In addition, as a high-price water injector, which has been employed in the conventional water injection system, is not applied the manufacturing cost may be lowered.

A water injection device 20 may be configured to inject a desired amount of water into the vaporization chamber 12 of the vaporization tank 11.

According to an exemplary embodiment of the present invention, the water injection device 20 may include a water tank 21 in which water is stored, and a water injection pipe 22 connecting the water tank 21 with the vaporization tank 11.

The water injection pipe 22 may be disposed therein with a pump 23, which pumps water from the water tank 21, and a filter 24 which filters pollutants from water.

According to an exemplary embodiment of the present invention having the above structure, when water is injected into the vaporization chamber 12 of the vaporization tank 11 by use of the water injection device 20, the water may be vaporized by the heat of the exhaust gas discharged through the exhaust system 2 of the internal combustion engine 1 wherein water vapor may be generated.

The water vapor may form a constant expansion pressure due to the vaporization. The water vapor may be supplied into the intake port 9 of the intake system 5 through the water vapor supply pipe 13 by the expansion pressure. The water vapor supplied into the intake port 9 may be introduced into a combustion chamber 1a of the internal combustion engine 1 as the intake valve 9a is opened.

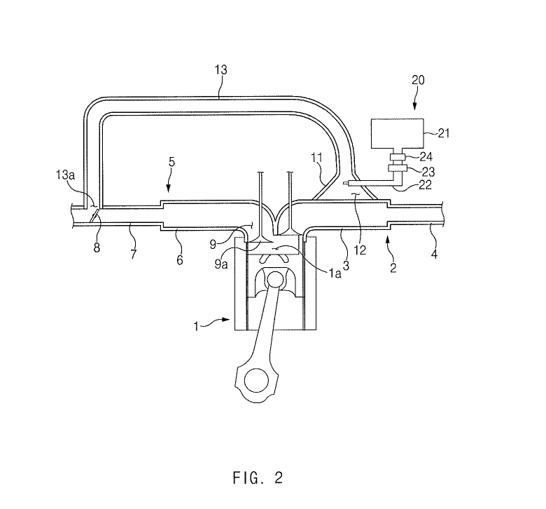

According another exemplary embodiment of the present invention, as illustrated in FIG. 2, the water vapor supply pipe 13 may connect the vaporization tank 11 with an intake pipe 7 of the intake system 5. The supplying opening 13a of the water vapor supply pipe 13 may communicate with a segment of the intake pipe 7 in which a throttle valve 8 is disposed. Accordingly, the water vapor supplied through the water vapor supply pipe 13 may be introduced into the combustion chamber 1a of the internal combustion engine 1 as the throttle valve 8 is opened.

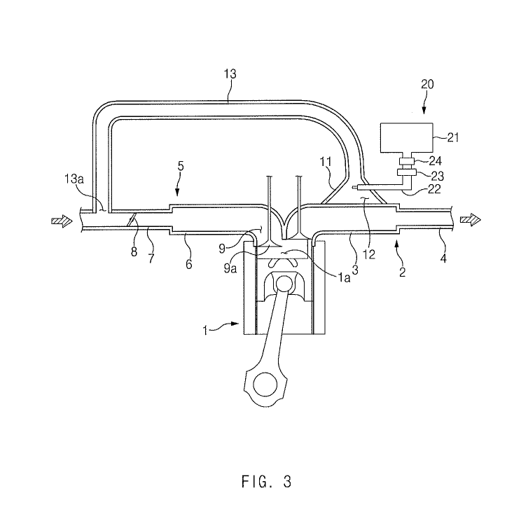

As illustrated in FIG. 3, the water vapor supply pipe 13 may connect the vaporization tank 11 with an intake manifold 6 of the intake system 5. The supplying opening 13a of the water vapor supply pipe 13 may communicate with one side of the intake manifold 6 of the intake system 5. Accordingly, the supplying opening 13a of the supplying pipe 13 may communicate with a downstream segment of the throttle valve 8 in the intake system 5. The water vapor supplied through the water vapor supply pipe 13 may be introduced into the combustion chamber 1a of the internal combustion engine 1 as the intake valve 9a is open.

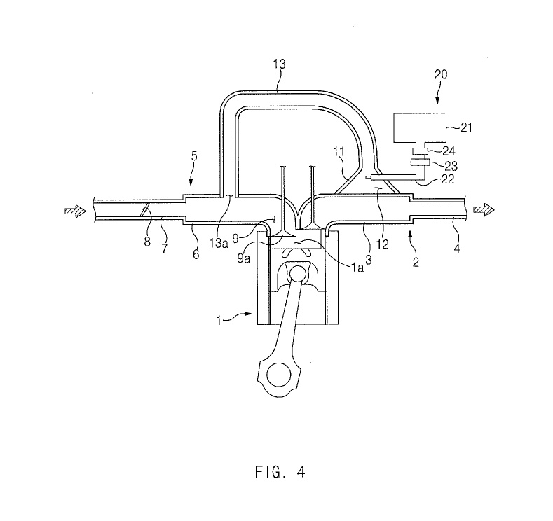

As illustrated in FIG. 4, the supplying opening 13a of the water vapor supply pipe 13 may communicate with an upstream segment of the throttle valve 8 in the intake pipe 7. Accordingly, the water vapor supplied through the water vapor supply pipe 13 may be introduced into the combustion chamber 1a of the internal combustion engine 1 as the throttle valve 8 is opened.

As described above, according to another exemplary embodiment of the present invention, as the supplying opening 13a of the water vapor supply pipe 13 communicates with the intake pipe 7 of the intake system 5, the same function and the same effect as those of the conventional water injection system may be implemented. In addition, as an EGR cooler and an EGR valve of a conventional EGR system are not employed, the manufacturing cost may be lowered.

As described above, according to an exemplary embodiment of the present invention, the water is vaporized by use of the heat of the exhaust gas discharged from the exhaust manifold of the internal combustion engine to form water vapor. The water vapor is supplied into the intake port of the intake system or the intake manifold. Accordingly, when the intake valve or the throttle valve is open, the water vapor may be introduced into the combustion chamber of the engine. Therefore, the combustion heat and the nitrogen oxide emissions may be reduced, and the fuel efficiency may be significantly improved.

For convenience in explanation and accurate definition in the appended claims, the terms “upper”, “lower”, “internal”, “outer”, “up”, “down”, “upwards”, “downwards”, “front”, “rear”, “back”, “inside”, “outside”, “inwardly”, “outwardly”, “internal”, “external”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chose and described to explain certain principles of the invention and their practical application, to enable others killed in the art to make and utilize various exemplary embodiments of the present invention, as well as various alternatives and modifications thereof. It is intended that the scope of the invention be defined by the Claims appended hereto and their equivalents.

What is claimed is:

1. A water vapor supply apparatus for an internal combustion engine, the water vapor supply apparatus comprising:
a vaporization tank in which water vapor is generated as water is vaporized by use of exhaust gas discharged from the internal combustion engine; and
a water injection device configured to inject the water to the vaporization tank,
wherein the water vapor generated from the vaporization tank is supplied into an intake system of the internal combustion engine.

2. The water vapor supply apparatus of claim 1, further including:
a water vapor supply pipe connecting the vaporization tank with the intake system of the internal combustion engine,
wherein the water vapor generated from the vaporization tank is supplied into the intake system of the internal combustion engine through the water vapor supply pipe.

3. The water vapor supply apparatus of claim 1, wherein the vaporization tank is disposed in an exhaust system of the internal combustion engine to receive heat of the exhaust gas discharged from the internal combustion engine, and
wherein a vaporization chamber, in which the water is vaporized, is formed in the vaporization tank.

4. The water vapor supply apparatus of claim 2, wherein the water vapor supply pipe connects the vaporization tank with an intake port of the intake system.

5. The water vapor supply apparatus of claim 4, wherein the water vapor supply pipe includes:
a supplying opening that communicates with the intake port of the intake system.

6. The water vapor supply apparatus of claim 2, wherein the water vapor supply pipe connects the vaporization tank with an intake pipe of the intake system.

7. The water vapor supply apparatus of claim 6, wherein the water vapor supply pipe includes:
a supplying opening that communicates with the intake port of the intake system.

8. The water vapor supply apparatus of claim 6, wherein the water vapor supply pipe includes:
a supplying opening that communicates with a segment of the intake pipe, in which a throttle valve is disposed.

9. The water vapor supply apparatus of claim 6, wherein the water vapor supply pipe includes:
a supplying opening that communicates with an upstream segment of a throttle valve in the intake pipe.

10. The water vapor supply apparatus of claim 2, wherein the water vapor supply pipe connects the vaporization tank with an intake manifold of the intake system.
